(19) United States
(12) Patent Application Publication
(10) Pub. No.: US 2023/0150189 A1
(43) Pub. Date: May 18, 2023

(54) ADDITIVE MANUFACTURING FROM A VELOCITY INDUCED DEAD ZONE

(71) Applicant: Carbon, Inc., Redwood City, CA (US)

(72) Inventors: Matthew Panzer, Redwood City, CA (US); Kyle Laaker, Redwood City, CA (US); John R. Tumbleston, Menlo Park, CA (US); Bob E. Feller, San Mateo, CA (US); Soren Rademacher, Chapel Hill, NC (US); Stephen Paul Land, Raleigh, NC (US); Henry Quarles Bibb, III, Zebulon, NC (US); David Shirvanyants, Chapel Hill, NC (US); Alexander Ermoshkin, Pittsboro, NC (US)

(21) Appl. No.: 17/754,518

(22) PCT Filed: Oct. 28, 2020
(86) PCT No.: PCT/US2020/057599

§ 371 Date: Apr. 5, 2022

Related U.S. Application Data
(60) Provisional application No. 62/947,763, filed on Dec. 13, 2019.

(51) Int. Cl. B29C 64/124; B33Y 10/00; B29C 64/223; B29C 64/245

(52) U.S. Cl. CPC B29C 64/124; B33Y 10/00; B29C 64/223; B29C 64/245

(57) ABSTRACT

Methods of making a three-dimensional object from a light polymerizable resin are described. A method may include: (a) providing a window, a light polymerizable resin, a laterally translatable substrate between said window and said resin to which said resin is adhered, and a carrier platform above said window; (b) irradiating said resin with light through said window and said translatable substrate, and vertically advancing said carrier away from said window, to produce a growing object on said carrier platform and consume resin beneath said growing object; and (c) laterally advancing said translatable substrate with said resin adhered thereto across said window to drag fresh resin beneath said growing object, continue producing said growing object and continue consuming fresh resin, until said three-dimensional object is produced.

### RELATED APPLICATION(S)

The present application claims priority from and the benefit of U.S. Provisional Application Ser. No. 62/947,763, filed Dec. 13, 2019, the disclosure of which is hereby incorporated herein in its entirety.

### FIELD OF THE INVENTION

The present invention concerns methods and apparatus for bottom-up additive manufacturing of three-dimensional objects with a light polymerizable resin.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (“CLIP”), coupled with the introduction of “dual cure” resins for additive manufacturing, has expanded the usefulness of stereolithography from prototyping to manufacturing (see, e.g., U.S. Pat. Nos. 9,211,678; 9,205,601; and 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

L. Robeson et al., PCT Patent Publication No. WO 2015/164234 (see also U.S. Pat. Nos. 10,259,171 and 10,434,706) describes the use of stationary and mobile (circulating) immiscible liquids as windows for bottom-up stereolithography. Robeson et al. particularly suggests the use of circulating pools for the purposes of cooling the pool and refreshing the oxygen content of fluorinated fluid pools. Similar technology sometimes described as “high area rapid printing” or “HARP” has subsequently been described by C. Mirkin et al., PCT Patent Publication No. WO 2017/210298 (see also U.S. Patent Application Publication No. 2019/0160733), and in D. Walker, J. Hedrick, and C. Mirkin, Science 366, 360-63 (18 Oct. 2019).

### SUMMARY OF THE INVENTION

In some embodiments described herein, a horizontally (or laterally) moving window with a no-slip (or “drag”) interface with a resin, drags fresh resin laterally through the illuminated region of a bottom-up additive manufacturing apparatus during exposure, creating a flow field with no stagnation points beneath the part. If the lateral velocity of the window is sufficiently fast, the resin near the window will not spend enough time in the light beam to cure, and will remain liquid near the window, sustaining a liquid interface (and thereby creating a velocity-induced dead zone). Near the part, there is also no-slip interface, and since the part is not moving horizontally, shear force causes the horizontal flow at the part side to be low, creating a polymerization zone where resin will cure to the part.

In prior techniques employing a slip interface, but without an oxygen-induced dead zone, such as described in Mirkin et al., there can be stagnation points in the liquid resin below the growing object that can cause the resin to cure up to the window interface when exposed to light (FIG. 1B). The cured resin will then “stick” to the interface causing problems such as part scalloping, uptake of the immiscible liquid into the part (e.g., a partially hollow part, print failure, or the like). The incorporation of a non-slip, or drag, interface serves to resolve these problems.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1A shows an idealized slip interface process, as suggested in “HARP,” for comparative purposes.

FIG. 1B shows a slip interface in which the interface is unstable, for comparative purposes.

FIG. 2A shows a drag interface as described herein.

FIG. 2B schematically shows a shear-induced dead zone in a drag interface process as described herein.

FIGS. 3A-3Q are a series of still photographs from an OCT video of an object being produced on a static, but oxygenated, immiscible liquid interface.

FIG. 4 is a schematic illustration of a sliding film printing apparatus.

FIG. 5 is a schematic illustration similar to FIG. 4, but with dimensions labelled.

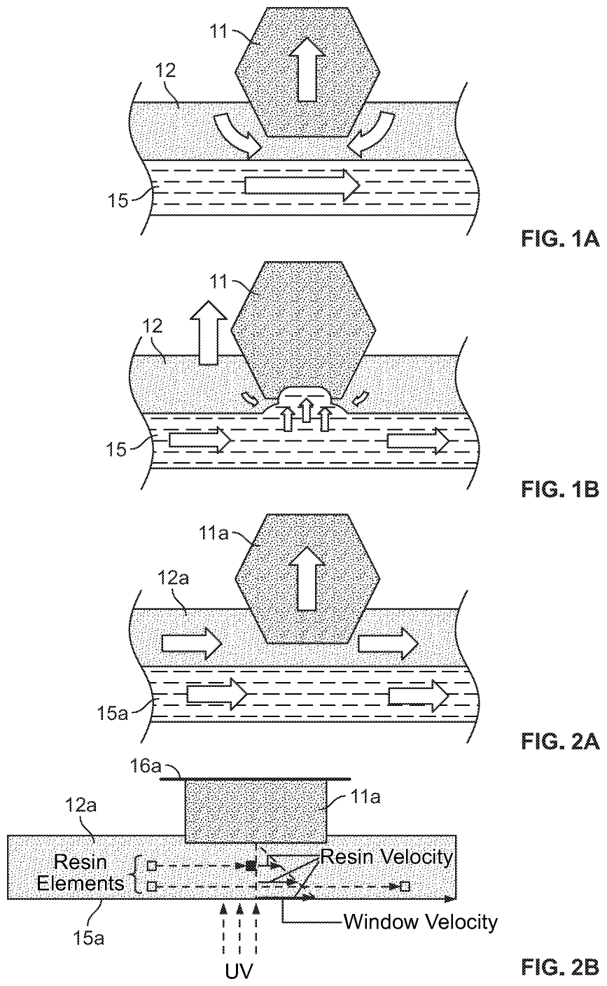

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

As used herein, the term “and/or” includes any and all possible combinations of one or more of the associated listed items, as well as the lack of combinations when interpreted in the alternative (“or”).

The methods described herein can be carried out with any suitable resin, including acid catalyzed polymerizable liquids (e.g., a free radical polymerizable resins or cationically polymerizable resins) and base catalyzed polymerizable liquid. Suitable examples, including but not limited to dual cure resins, are described in J. DeSimone et al., U.S. Pat. Nos. 9,211,678 and 9,216,546; J. Rolland et al., U.S. Pat. Nos. 9,676,963 and 9,598,606; L. Robeson et al., U.S. Pat. Nos. 10,259,171 and 10,434,706; and C. Mirkin et al., U.S. Patent Application Publication No, 2019/0160733, the disclosures of which are incorporated herein by reference in their entirety.

Apparatus for carrying out the present invention can be as known in the art, such as described in L. Robeson et al., U.S. Pat. Nos. 10,259,171 and 10,434,706; and C. Mirkin et al., U.S. Patent Application Publication No. 2019/0160733, the disclosures of which are incorporated herein by reference in their entirety, or modifications and combinations thereof that will be apparent to those skilled in the art.

Embodiments of the present invention are directed to a method of making a three-dimensional object (e.g., 11, 11a) from a light polymerizable resin (see, e.g., FIGS. 2A-2B). Some embodiments of the present invention are directed to an apparatus configured to carry out methods of making a three-dimensional object described herein.

In some embodiments, a method of making a three-dimensional object may comprise providing a window 15, a light polymerizable resin 12a, a laterally translatable substrate 15a between the window 15 and the resin 12a to which the resin 12a is adhered, and a carrier platform 16a above the window 15.

In some embodiments, the method of the present invention may further comprise irradiating the resin 12a with light through the window 15 and the translatable substrate 15a, and vertically advancing the carrier platform 16a away from the window 15 to produce a growing object 11a on the carrier platform 16a and consuming resin 12a beneath the growing object 11a. In some embodiments, the resin (12a) may be irradiated with light through the window 15 and the translatable substrate 15a while vertically advancing the carrier platform 16a away from the window 15 to produce the growing object 11a on the carrier platform 16a and consuming resin 12a beneath the growing object 11a.

In some embodiments, the method of the present invention may further comprise laterally advancing the translatable substrate 15a, with the resin 12a adhered thereto, across the window 15 to drag fresh resin 12a beneath the growing object 11a, continue producing the growing object 11a and continue consuming fresh resin 12a, until a three-dimensional object 11 is produced. In some embodiments, the resin 12a may be irradiated to produce a growing object 11a while also laterally advancing the translatable substrate 15a, with the resin 12a adhered thereto, across the window 15.

In some embodiments, methods of the present invention may further comprise cooling the translatable substrate 15a.

In some embodiments, the irradiating step may be carried out continuously, intermittently, or a combination thereof.

In some embodiments, the step of vertically advancing the carrier platform 16a may be carried out continuously, intermittently, or a combination thereof. In some embodiments, the vertically advancing step may be carried out unidirectionally for at least a portion of the producing of a three-dimensional object 11. In some embodiments, the vertically advancing step may be carried out reciprocally (i.e., in a pumped mode) for at least a portion of the producing of a three-dimensional object 11.

In some embodiments, the step of laterally advancing the translatable substrate 15a may be carried out continuously, intermittently, or a combination thereof.

In some embodiments, the vertically advancing and laterally advancing steps may be carried out under conditions in which liquid contact is maintained by the resin 12a between the growing object 11a and the translatable substrate 15a. In some embodiments, the laterally advancing step may be carried out at a velocity sufficient to create a velocity induced dead zone in the resin 12a, with the dead zone contacting the translatable substrate 15a. In some embodiments, the conditions may create a shear-induced polymerization zone (e.g., a gradient of polymerization zone) in the resin 12a between the dead zone and the object 11a.

In some embodiments, the translatable substrate 15a may carry oxygen. In some embodiments, the translatable substrate 15a may comprise an oxygen-permeable or oxygen-impermeable film (e.g., a fluoropolymer film). In some embodiments, the translatable substrate 15a may comprise a continuous loop. In some embodiments, the translatable substrate 15a may comprise an immiscible liquid (e.g., a silicone oil, a fluorinated oil, etc.).

In some embodiments, the resin 12a may be wettable on (i.e., adheres to) the immiscible liquid.

Further aspects of the present invention are set forth in the non-limiting examples below.

### Example 1

### Optical Coherence Tomography (OCT) Imaging of a 30 Object Grown from an Oxygenated PEPE Oil

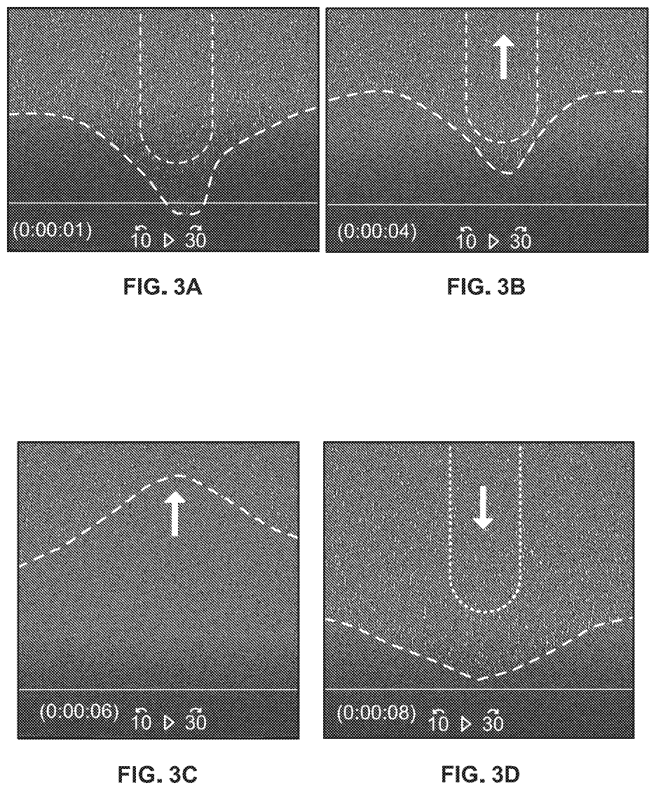

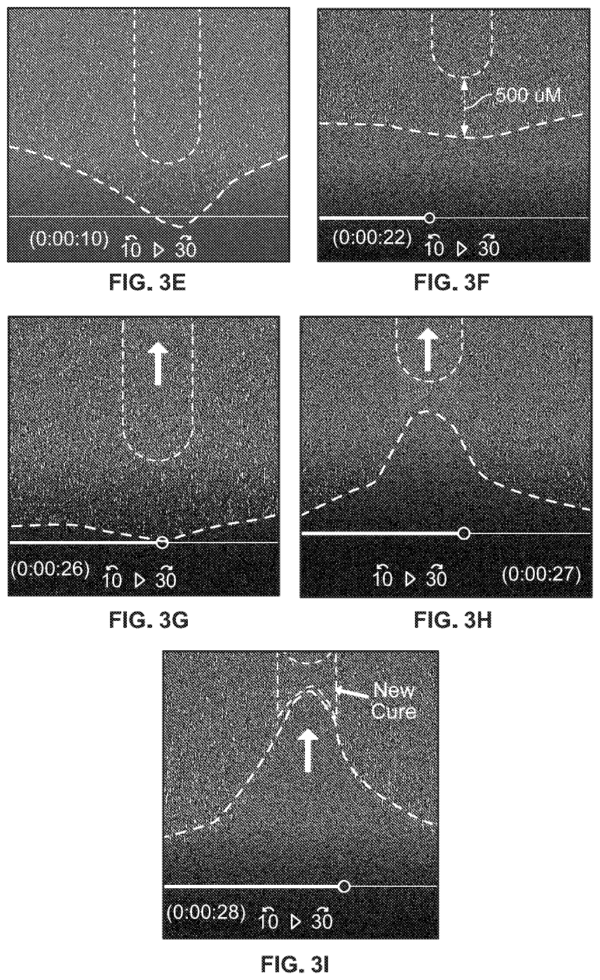

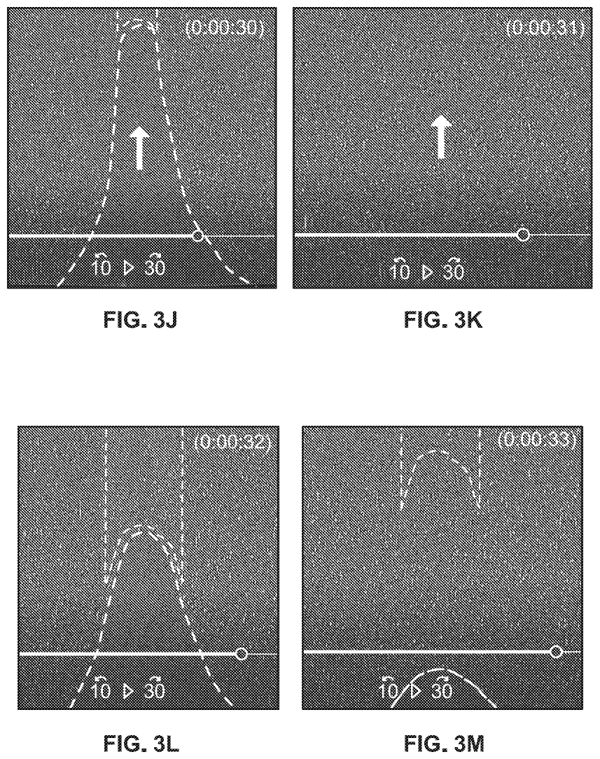

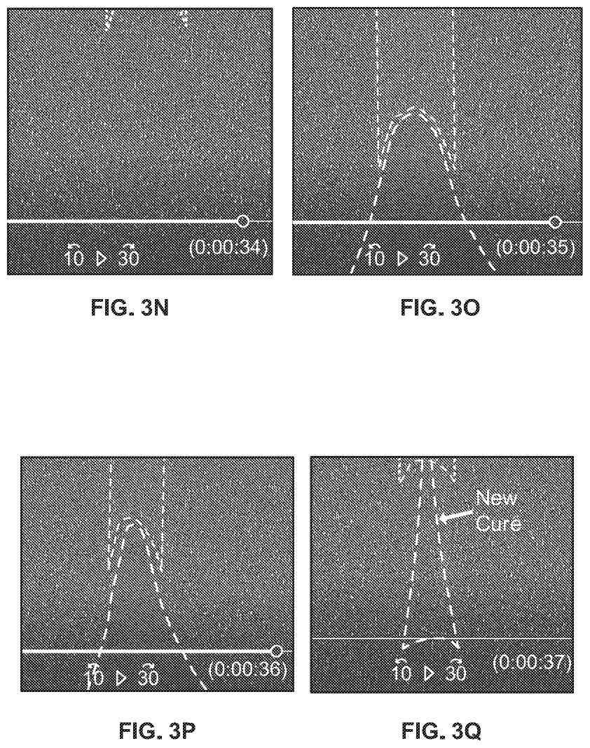

A cylinder 2 mm in diameter and 10 mm in length was produced as a test object in a pumped (reciprocal) operating mode, with a transition to a continuous mode, on a perfluoropolyether (PFPE) oil. Sequential screen shots of the video are provided in FIGS. 3A-3Q. A dead zone in both pumped and continuous mode was clearly seen under these conditions. The part made was significantly “scalloped” due to the dynamics in continuous mode that were readily seen.

Materials and Methods: The measurement is done on a basic bottom-up additive manufacturing device such as described U.S. Pat. No. 9,211,678 to DeSimone et al. and in J. Tumbleston et al., Science 347, 1349-1352 (2015), but with a glass window rather than a fluoropolymer window, and with a PFPE oil as an immiscible liquid on the window, beneath the resin. Optical Coherence Tomography (“OCT”) was carried out with a Ganymede series spectral domain OCT imaging system from THORLABS, with a central wavelength of 930 nm and axial resolution of 4.4 μm. Other details are as follows:
Resin: PR Clear
Intensity: ˜4.5 mW/cm2
Resin Dc=2.9
Resin alpha=0.00029 μm−1 (cure depth=1500 um)
Continuous print speed=350 mm/h
Pumped mode pump height=2.5 mm
Part height offset at start of continuous transition=500
Immicible liquid: KRYTOX™ GPL 101 PFPE oil
Immicible liquid oxygen content: equilibrated with atmosphere
Immicible liquid conditions: static, no lateral flow
Immicible liquid thickness: 5.0 mm
Estimated deadzone thickness: ˜45

Results: Note that the aspect ratio in FIGS. 3A-3Q is not 1:1, but is about 10:1 (that is, the actual z (or vertical) dimension is much smaller that the xy (or lateral) dimension).

The resin is a low light absorbance (low alpha) resin (1500 μm penetration depth), similar to what is used in in D. Walker, J. Hedrick, and C. Mirkin, Science 366, 360-63 (18 Oct. 2019) (˜800 μm) and is loaded with nanoparticles (detailed print parameters below). The dark uniform area beneath the resin is the fluorinert. The fluorinert is oxygenated, but stagnant in this experiment

The video started when the print had been running for 2.5 mm in pumped mode. There are then two pumps that show the cure dynamics in this mode (partly shown in FIGS. 3A-3E). The dead zone (referred to by Walker et al. as a “cure zone”) can clearly seen in these.

After the two pumps, the part stops 500 μm above the liquid interface, and there is a 10 second delay. During the delay the focal spot of the microscope was adjusted so the cure zone is in the microscope sweet spot, which makes the interface look like it moved (from FIGS. 3F to 3G) (the part is barely visible).

Then the continuous mode was started (FIGS. 3H-3Q) with a pull speed of 350 mm/h. It can be seen that, as the resin cures the dead zone is also present, and that the interface behaves like a liquid tensioned window. When the part first begins to move, the interface and resin move with it, and the flow is rather stagnant in the build zone. Consequently, the resin flash-cures toward the interface up to the deadzone. There is no induction-time induced cure zone due to the stagnation of the resin. The lack of flow induced dead zone cause the liquid window interface to be pulled up with part. The part eventually snaps back due to density differences, and perhaps interface tension. Then the process repeats yielding oscillations, and creating the scalloped surface in the object.

Discussion: The continuous print mode is unstable due to the nearly stagnant flow of resin between the part and the interface, obstructing the formation of induction time-induced cure zone. To obviate this problem without an oxygen-induced dead zone, flow in the window can be used to drag in resin across the build zone. A slip boundary between the resin and the immiscible liquid would undermine this mechanism, thus a no-slip would be beneficial.

### Example 2

### OCT Imaging of a 3D Object Grown from a De-Oxygenated PIPE Oil

This experiment was carried out in like manner as Example 1 above, except that the PFPE oil was de-oxygenated by placing it in a container with significant empty space and filled the empty space with pure nitrogen, so that oxygen then diffuses out of the resin. A negligible dead zone was clearly seen. In this case, OCT imaging showed that the liquid interface did not release from the growing part and continued to entrain the window fluid in the part, leading to a visibly (and undesirably) hollowed-out part.

### Example 3

### A Sliding Film Printing Apparatus

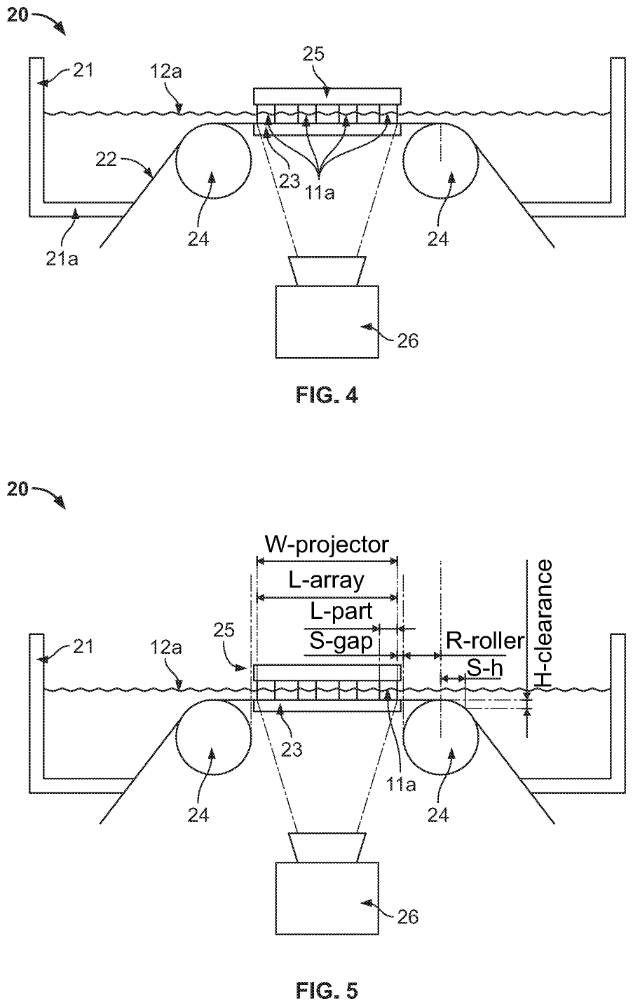

An apparatus (20) for carrying out a process as described herein is shown in FIG. 4 and consists of a vat (21) with a film (22) covered window (23) at the vat floor (21a). Instead of fixing the film (22) against the window (23), the film (22) is movable and is actuated by a roller system (24). This allows for the sliding film (22) to induce a shearing action to pump resin between part build surfaces (e.g., growing objects 11a) and the film (22) (and in some embodiments create a velocity-induced dead zone as described above). Sliding film printing could be advantageous when printing arrays of smaller parts (11) since the film (22) only needs to translate proportional to the length of a single part (11) in the array, not the length of the whole array.

In the Sliding Film Printing (SFP) process, the part(s) (11) and stage (25) remain stationary in the X-plane. The film (11) and build region of the part(s) are both submerged in a vat (21) of resin (12a). Resin (12a) is resupplied to the slice thickness region between the part(s) (11a) and the film (22) by translating the film (22) under the stationary part(s) (11a). The recurring slice steps are as follows:
1) Slide the film (22) under the part(s) (11a) in the x-direction
2) Expose the next frame (i.e., to light via a light engine 26)
3) Step the stage (25) to the next z-position

Preliminary experimental results have shown that sliding the film (22) a distance greater than the maximum individual part length in the x-direction is beneficial and possibly required to fully supply resin (12a) to under the part(s) (11a) and to ensuring that the window (23) (film (22)) surface has been restored to fully parallel to the bottom of the part (11a) after the previous z-step. The time to slide (G_{slide}) is a function of the maximum part length (Lₚₐᵣₜ), the slide distance multiple (sₘᵤₗₜ), and the slide velocity (v_{slide}). Pertinent dimensions of the apparatus (20) are shown in FIG. 5.

$${t}_{slide} = \frac{{L}_{part} \times {s}_{mult}}{{v}_{slide}}$$

Total slice time (t_{slice}) is the sum of slide time (G_{slide}), exposure time (tₑₓₚ), and z-step time (t_{z}):

$${t}_{slice} = \frac{{L}_{part} \times {s}_{mult}}{{v}_{slide}} + {t}_{exp} + {t}_{z}$$

The foregoing is illustrative of the present invention, and is not to be construed as limiting thereof. The invention is defined by the following claims, with equivalents of the claims to be included therein.

1. A method of making a three-dimensional object from a light polymerizable resin, comprising:
(a) providing a window, a light polymerizable resin, a laterally translatable substrate between said window and said resin to which said resin is adhered, and a carrier platform above said window;
(b) irradiating said resin with light through said window and said translatable substrate, and vertically advancing said carrier away from said window, to produce a growing object on said carrier platform and consume resin beneath said growing object; and
(c) laterally advancing said translatable substrate with said resin adhered thereto across said window to drag fresh resin beneath said growing object, continue producing said growing object and continue consuming fresh resin, until said three-dimensional object is produced,
wherein said laterally advancing step is carried out at a velocity sufficient to create a velocity induced dead zone in said resin, with said dead zone contacting said translatable substrate to create a no-slip interface between said resin and said translatable substrate.

2. The method of claim 1, wherein said vertically advancing step is carried out continuously, intermittently, or a combination thereof, and wherein said irradiating step is carried out continuously, intermittently, or a combination thereof.

3. The method of claim 1, wherein said vertically advancing step is carried out unidirectionally for at least a portion of the producing of said three-dimensional object.

4. The method of claim 1, wherein said vertically advancing step is carried out reciprocally for at least a portion of the producing of said three-dimensional object.

5. The method of claim 1, wherein said laterally advancing step is carried out continuously, intermittently, or a combination thereof.

6. The method of claim 1, wherein said vertically advancing and laterally advancing steps are carried out under conditions in which liquid contact is maintained by said resin between said growing object and said translatable substrate.

7. (canceled)

8. The method of claim 1, wherein said conditions create a shear-induced polymerization zone in said resin between said dead zone and said object.

9. The method of claim 1, wherein said translatable substrate carries oxygen, and wherein said resin comprises an acid catalyzed polymerizable liquid or a base catalyzed polymerizable liquid.

10. The method of claim 1, further comprising the step of: (d) cooling said translatable substrate.

11. The method of claim 1, wherein said translatable substrate comprises an oxygen-permeable or oxygen-impermeable film.

12. The method of claim 11, wherein said translatable substrate comprises a continuous loop.

13. The method of claim 1, wherein said translatable substrate comprises an immiscible liquid.

14. The method of claim 13, wherein said resin is wettable on said immiscible liquid.

15. A method of making a three-dimensional object from a light polymerizable resin, comprising:
(a) providing a window, a light polymerizable resin, a laterally translatable substrate between said window and said resin to which said resin is adhered, and a carrier platform above said window;
(b) irradiating said resin with light through said window and said translatable substrate, and vertically advancing said carrier away from said window, to produce a growing object on said carrier platform and consume resin beneath said growing object, wherein said vertically advancing and laterally advancing steps are carried out under conditions in which liquid contact is maintained by said resin between said growing object and said translatable substrate; and
(c) laterally advancing said translatable substrate with said resin adhered thereto across said window to drag fresh resin beneath said growing object, continue producing said growing object and continue consuming fresh resin, until said three-dimensional object is produced,
wherein said laterally advancing step is carried out at a velocity sufficient to create a velocity induced dead zone in said resin, with said dead zone contacting said translatable substrate to create a no-slip interface between said resin and said translatable substrate, and wherein said conditions create a shear-induced polymerization zone in said resin between said dead zone and said object, and
wherein said translatable substrate comprises an oxygen-permeable film or an oxygen-impermeable film.
